(19) United States
(12) Patent Application Publication
(10) Pub. No.: US 2014/0322530 A1
(43) Pub. Date: Oct. 30, 2014

(54) MULTILAYER COEXTRUDED FILM, IN PARTICULAR PACKAGING FILM

(71) Applicant: Mondi Consumer Packaging Technologies GmbH, Gronau (DE)

(72) Inventors: Herbert BADER, Nordwalde (DE); Joachim HAWIGHORST, Georgsmarienhuette (DE)

(73) Assignee: Mondi Consumer Packaging Technologies GmbH, Gronau (DE)

(21) Appl. No.: 14/260,362

(22) Filed: Apr. 24, 2014

(30) Foreign Application Priority Data
Apr. 30, 2013 (EP) 13166028.4

(51) Int. Cl. B32B 27/08; B32B 27/32

(52) U.S. Cl. CPC B32B 27/08; B32B 27/32; B32B 27/327; B32B 2250/03; B32B 2250/40; B32B 2553/00; B32B 2439/46
USPC 428/354

(57) ABSTRACT

The invention relates to a multilayer film produced by coextrusion, more particularly packaging film, having a core layer comprising a core layer mixture, a seal layer comprising a seal layer mixture, and a print layer comprising a print layer mixture. The core layer is disposed between the seal layer and the print layer, and in accordance with the invention comprises at least one polyolefin and starch, preferably thermoplastic starch. The seal layer mixture and the print layer mixture comprise in each case at least one polyolefin and in each case starch, preferably thermoplastic starch.

The invention relates to a multilayer film produced by coextrusion, more particularly packaging film, having a core layer comprising a core layer mixture, a seal layer comprising a seal layer mixture, and a print layer comprising a print layer mixture.

Multilayer packaging films of the aforementioned kind are known in principle from the art. To reduce the use of oil-based products, such as polyolefins, a known approach is to replace some of the polymer present in the core layer mixture by starch. WO 2011/009165 A1 describes a three-layer film whose core layer may comprise between 10 and 80 wt % of thermoplastic starch. A disadvantage affecting the films known from the art, however, is that replacing some of the polymer of the core layer mixture by the starch has the effect of significantly reducing, in particular, the tensile strength of the film. As a result, the films easily tear, thereby limiting the possibility for use of such films in the packaging sector, owing to the high mechanical stresses associated with the filling operation. In view of the rising prices for oil, however, a high proportion of renewable raw materials in the film is an objective.

The technical problem addressed by the invention, therefore, is that of specifying a film of the aforementioned kind which, with a high fraction of renewable raw materials, is notable for a high mechanical strength, and can be easily produced.

In order to solve the technical problem, the invention teaches a multilayer film produced by coextrusion, more particularly packaging film, having a core layer comprising a core layer mixture, a seal layer comprising a seal layer mixture, and a print layer comprising a print layer mixture, the core layer being disposed between the seal layer and the print layer, the core layer mixture comprising at least one polyolefin and starch, preferably thermoplastic starch, and the seal layer mixture and the print layer mixture comprising in each case at least one polyolefin and in each case starch, preferably thermoplastic starch. The film may be used more particularly for the production of pouch packaging. The film of the invention is used with particular preference for producing wicket pouches, which are used primarily in the hygiene and cosmetics sectors. Laid-flat pouches are prefabricated from a roll of film, and are charged in a packaging machine with a stack of wickets introduced into the packaging machine: for example, a plurality of diapers assembled into a stack. A major problem solved by the invention is that of achieving the film strengths necessary for the packaging operation. Because of the high packing speed, the film, when being packed, is subject to strong mechanical stresses. The pouches are opened and the product stack is inserted into the pouch. In the course of these operations, the film must not be stretched excessively, and must also not tear, of course. It is important for the film to have a sufficiently high strength over a stretch of up to 10% and for the seal layer mixture to be readily sealable with formation of strong seal seams.

The core layer of the film of the invention is disposed sandwichlike between the seal layer and the print layer. The starch in the context of the invention is, for example, corn starch. The use of other starches is in principle also possible. Preferably a thermoplastic starch (TPS) is used in all layers of the film. The film of the invention is therefore distinguished by a high fraction of renewable raw materials, with the renewable raw materials, preferably the thermoplastic starch, being disposed in all layers of the film producible by coextrusion. As a result of the distribution of the starch in all layers of the film, trouble-free extrudability of the film is ensured. The core layer, seal layer, and print layer are distinguished by similar or substantially identical flow and stretch properties, and so there can be no instabilities during the coextrusion of the individual layers, thereby preventing, for example, melt breakage, uneven surfaces, or fluctuations in thickness.

The starch content of the core layer mixture is appropriately higher than, and preferably at least twice as high and more preferably at least three times as high as, the starch content of the print layer mixture and/or seal layer mixture. It has emerged as advantageous that the starch content of the print layer mixture is greater than the starch content of the seal layer mixture. This ensures that the seal layer ensures reliable sealability of the film. Furthermore, the print layer formed from the print layer mixture is readily printable. The mattness of the print layer surface of the film can be influenced by adjusting the starch content of the print layer mixture.

The core layer mixture appropriately comprises between 5 and 50 wt % of starch. The core layer or core layer mixture preferably comprises 5 to 20 wt % of starch. The print layer mixture and the seal layer mixture comprise in each case 2 to 25 wt % and preferably 3 to 12 wt % of starch. This ensures the sealability of the seal layer and the printability of the print layer, respectively. It is possible for the starch content of the print layer mixture to be exactly or approximately the same as the starch content of the seal layer mixture. It is advisable for the starch to be present in the form of TPS compound in the core layer mixture and/or seal layer mixture and/or print layer mixture. The TPS compound appropriately comprises 40 to 50 wt % of starch and 60 to 50 wt % of processing additives, which processing additives comprise, for example, polyhydric alcohols, in particular glycerol and/or sorbitol, advisedly fatty acids and/or fatty-acid salts, ethylene-acrylic acid copolymers and/or, optionally, at least one polyethylene.

It has emerged as advantageous for the core layer mixture to comprise as polyolefin at least one polypropylene. Through the use of polypropylene, the core layer, and hence the film as well, is distinguished by outstanding strength. The use of a propylene block copolymer (PP-BC) has emerged as advantageous. It is within the bounds of the invention for the PP-BC to be formed of propylene and at least one α-olefin. Advisedly the core layer comprises a propylene random copolymer (PP-RC). The PP-RC has the effect, in particular, of improving the adhesion between the individual layers, and also the flow behavior of the core layer during extrusion. The use of PP-RC has been proven particularly when PP-BC or a mixture of PP-BC and a polypropylene homopolymer (PP-H) is used in the core layer mixture. The polypropylene appropriately possesses a melt flow index MFI of more than 1 (measured in accordance with DIN 53735, testing conditions 230° C./2.16 Kg). Advisedly the core layer mixture comprises at least 15 to 60 wt % and preferably 20 to 50 wt % of polypropylene. The core layer mixture preferably comprises 15 to 40 wt % and more preferably 20 to 30 wt % of a PP-BC. The core layer mixture preferably comprises 5 to 30 wt % and more preferably 10 to 20 wt % of a PP-RC.

In accordance with one embodiment of the invention, the core layer mixture comprises as polyolefin at least one polyethylene. For example, the core layer mixture has 5 to 35 wt %, preferably 15 to 25 wt %, and more preferably about 20 wt % of a polyethylene. The polyethylene used is advantageously a metallocene-catalyzed linear low-density polyethylene (mLLDPE). By virtue of the polyethylene, the core layer acquires an improved tensile strength. Moreover, the tear resistance of the core layer and hence of the film is increased. The use of an mLLDPE with 1-hexene as comonomer has emerged as particularly advantageous. This polymer is also identified as mLLDPE-C6. In principle it is also possible for α-olefins, such as 1-butene or 1-octene, for example, to be added as comonomers to the mLLDPE. Advisedly the melt flow index MFI of the polyethylene is more than 1.5 (measured in accordance with DIN 53735, testing conditions 190°/2.16 Kg).

The seal layer mixture and/or the print layer mixture appropriately comprise in each case at least one polypropylene. Advantageously, the polypropylene present in the seal layer mixture and/or in the print layer mixture is a polypropylene random copolymer (PP-RC). The PP-RC advantageously has a comonomer fraction of at least 4 wt %, based on the mass of the PP-RC. A particularly preferred comonomer used is ethylene. Through the use of a polypropylene copolymer and more preferably through the PP-RC, improvements are made in particular in the adhesion between the seal layer and the core layer, and between the core layer and the print layer. The use of a polypropylene copolymer in the film makes delamination of the individual layers more difficult. It is within the bounds of the invention for the seal layer mixture and/or the print layer mixture to comprise in each case 5 to 50 wt % and preferably in each case 10 to 35 wt % of polypropylene.

It has proven appropriate for the seal layer mixture and/or the print layer mixture to comprise in each case as polyolefin a polyethylene. The polyethylene in the seal layer advantageously ensures the sealability of the film. In accordance with one embodiment, the seal seam strength (measured in accordance with ISO 527, sealing conditions: temperature 140° C., pressure=3 bar, time=0.5 s) is approximately 11N. The polyethylene present in the seal layer mixture and/or in the print layer mixture is appropriately at least one component selected from the group “low density polyethylene (LDPE), linear low density polyethylene (LLDPE), metallocene-catalyzed linear low density polyethylene (mLLDPE)”. The polyethylene present in the seal layer mixture and/or in the print layer mixture, preferably mLLDPE, preferably comprises as comonomer at least one α-olefin, in which case 1-butene, 1-hexene and/or 1-octene, for example, may be used as α-olefin. With particular preference the comonomer in the mLLDPE is 1-hexene.

In accordance with one preferred embodiment, the seal layer mixture and/or the print layer mixture and/or the core layer mixture each have at least one compatibilizer. The compatibilizer is, so to speak, an adhesion promoter, bonding the polar groups of the starch with the polypropylene by electrostatic interactions. A particularly preferred compatibilizer used is a maleic anhydride-grafted polypropylene, preferably polypropylene copolymer (PP-g-MAn). It is within the bounds of the invention for the seal layer mixture and/or the print layer mixture and/or the core layer mixture to comprise in each case 1 to 10 wt % of the compatibilizer. It is possible for the fraction of the compatibilizer in the core layer mixture to be greater than the fraction of the compatibilizer in the seal layer mixture and/or print layer mixture. Advisedly the seal layer mixture and/or the print layer mixture have in each case 1 to 10 wt % of the compatibilizer and preferably 1 to 5 wt % of the compatibilizer. In accordance with one embodiment, the core layer mixture and/or the seal layer mixture each comprise a lubricant. The seal layer mixture or the seal layer is preferably to be designed with a high lubricity. Particular preference is given to lubricant-free embodiments of the print layer mixture and print layer. It has been found that the use of a lubricant in the print layer disrupts the printability or the adhesion of ink to the print layer, since the lubricant migrates to the surface of the print layer. In accordance with one possible embodiment of the invention, the core layer mixture has at least one further adjuvant. The further adjuvant may be, for example, a pigment or a dye, or a mixture of dyes. The print layer mixture and/or seal layer mixture are in each case advantageously adjuvant-free, more particularly pigment-free and/or dye-free, in their form. By disposition of the core layer between the seal layer and the printed publication, the core layer during extrusion of the multilayer film, as the core layer emerges from a die gap, does not enter into direct contact with a die of the blowing head for producing the multilayer film.

In accordance with one embodiment, the film has a thickness of approximately 50 μm. It is possible for the print layer and the seal layer to have the same thickness. The core layer is advantageously thicker than the print layer and/or seal layer. In accordance with one particularly preferred embodiment, the core layer is at least twice as thick as the print layer and/or seal layer.

The invention is based on the finding that the film of the invention can be readily extruded in spite of the high fraction of renewable raw materials (starch or TPS). It is important here that all layers of the film include starch, as a result of which the film of the invention is distinguished by a largely symmetrical layer structure. The sandwichlike arrangement of the core layer between the print layer and the seal layer means that the core layer during extrusion, on emergence from a die gap, has no contact with, for example, metal surfaces of the die of the blowing head. Contact between the starch-rich and optionally pigment-containing core layer and the die may lead to the development of deposits on the die gap, resulting in disruptions during production of the multilayer film. Since the core layer is separated by the print layer and the seal layer from the surfaces on the die gap, the formation of deposits—which may be caused, for example, by the high starch content of the core layer and/or by additives present in the core layer—is avoided. The film of the invention is notable in particular for a high strength and resistance to delamination. It has been found that the film of the invention is readily printable and sealable. In spite of the starch present in the seal layer, surprisingly, the seal seam strength attainable with the seal layer does not suffer any deterioration, or suffers only insubstantial deterioration.

### EXAMPLES

### Example 1

### TPS-PE-PP Blown Film 50 μm (Renewables Fraction: 10%)

| Print layer | Core layer | Seal layer |
|---|---|---|
| A (12 μm) | B (26 μm) | C (12 μm) |
| 45% mLLDPE | 25% PP-BC | 43% mLLDPE |
| 23% LDPE | 20% TPS compound | 20% LDPE |
| 20% PP-RC | 19% mLLDPE | 19% PP-RC |
| 10% TPS compound | 15% white masterbatch | 10% TPS compound |
| 2% PP-g-MAn | 15% PP-RC | 6% lubricant masterbatch |
| | 3% PP-g-MAn | 2% PP-g-MAn |
| | 3% lubricant masterbatch | |

### Example 2

### TPS-PE-PP Blown Film 50 μm (Renewables Fraction: 20%)

| Print layer | Core layer | Seal layer |
|---|---|---|
| A (12.5 μm) | B (25 μm) | C (12.5 μm) |
| 45% mLLDPE | 25% PP-BC | 43% mLLDPE |
| 23% LDPE | 40% TPS compound | 20% LDPE |
| 20% PP-RC | 18% mLLDPE | 19% PP-RC |
| 20% TPS compound | 15% white masterbatch | 10% TPS compound |
| 2% PP-g-MAn | 15% PP-RC | 6% lubricant masterbatch |
| | 4% PP-g-MAn | 2% PP-g-MAn |
| | 3% lubricant masterbatch | |

### Comparative Example

### LDPE/LLDPE 50 μm

| Print layer | Core layer | Seal layer |
|---|---|---|
| A (14 μm) | B (22 μm) | C (14 μm) |
| 60% LLDPE | 70% LLDPE | 65% LLDPE |
| 40% LDPE | 15% LDPE | 32% LDPE |
| | 15% white masterbatch | 3% lubricant antiblock |
| | | masterbatch |

The measurement results from measurements of the mechanical properties, of the sealing strength, and opacity are reproduced in the table below.

### Measurement Values:

| Film | | | | Comparison film | | |
|---|---|---|---|---|---|---|
| parameter | Method | Direction | Unit | (LDPE/LLDPE) | Example 1 | Example 2 |
| Renewable | Calc. | — | % | 0 | 10 | 20 |
| content | | | | | | |
| Thickness | ISO 4593 | — | μm | 50 | 50 | 50 |
| Tensile | ISO 527 | MD | N | 15 | 20 | 17 |
| force @ 10% | ISO 527 | CD | N | 17 | 19 | 16 |
| Elongation | ISO 527 | MD | % | 888 | 577 | 579 |
| @ break | ISO 527 | CD | % | 1038 | 717 | 717 |
| COFs | ISO 8295 | — | 1 | 0.18 | 0.20 | 0.18 |
| inside/inside | | | | | | |
| Sealing | ISO 527 | 140° C./ | N | 11 | 11 | 8 |
| strength | | 3 bar/0.5 s | | | | |
| Opacity | ISO 6504-3 | — | % | 67 | 65 | 65 |

1-23. (canceled)

24. A multilayer film produced by coextrusion, having a core layer comprising a core layer mixture, a seal layer comprising a seal layer mixture, and a print layer comprising a print layer mixture, the core layer being disposed between the seal layer and the print layer, the core layer mixture comprising at least one polyolefin and starch, and the seal layer mixture and the print layer mixture comprising in each case thermoplastic starch (TPS), polyopropylene random copolymer (PP-RC) and polyethylene (PE).

25. The multilayer film according to claim 24, in which the starch content of the core layer mixture is higher than the starch content of the print layer mixture and/or seal layer mixture.

26. The multilayer film according to claim 24, in which the core layer mixture comprises between 5 and 50 wt % of starch.

27. The multilayer film according to claim 24, in which the print layer mixture and/or the seal layer mixture comprise in each case 2 to 25 wt % of starch.

28. The multilayer film according to claim 24, in which the core layer mixture comprises as polyolefin at least one polypropylene.

29. The multilayer film according to claim 28, in which the polypropylene has a melt flow index (MFI) of more than 1.

30. The multilayer film according to claim 28, in which the core layer mixture comprises a polypropylene block copolymer (PP-BC).

31. The multilayer film according to claim 30, in which the polypropylene block copolymer PP-BC in the core layer mixture is 15 to 40 wt %.

32. The multilayer film according to claim 27, in which the core layer mixture comprises a polypropylene random copolymer (PP-RC).

33. The multilayer film according to claim 32, in which the PP-RC in the core layer mixture is 5 to 30 wt %.

34. The multilayer film according to claim 30, in which the polypropylene block copolymer contains a comonomer fraction in an amount of more than 4 wt %.

35. The multilayer film according to claim 28, in which the core layer mixture comprises 15 to 60 wt % of polypropylene.

36. The multilayer film according to claim 24, in which the core layer mixture comprises as polyolefin at least one polyethylene.

37. (canceled)

38. The multilayer film according to claim 24 in which the seal layer mixture and/or the print layer mixture comprise in each case 10 to 30 wt % of polypropylene.

39. (canceled)

40. The multilayer film according to claim 24, in which the polypropylene random copolymer contains a comonomer fraction of more than 4%.

41. The multilayer film according to claim 24 in which the polypropylene random copolymer has a melt flow index (MFI) of more than 1.

42. (canceled)

43. The multilayer film according to claim 24, in which the polyethylene present in the seal layer mixture and/or in the print layer mixture comprises at least one component selected from the group consisting of LDPE, LLDPE, and metallocene-catalyzed LLDPE (mLLDPE).

44. The multilayer film according to claim 24, in which the seal layer mixture and/or the print layer mixture and/or the core layer mixture has in each case at least one compatibilizer.

45. The multilayer film according to claim 44, in which the seal layer mixture and/or the print layer mixture and/or the core layer mixture comprise 1 to 10 wt % of the compatibilizer.

46. The multilayer film according to claim 24, in which all layers comprise a polypropylene random copolymer.

47. The multilayer film according to claim 24 in which the multilayer film is a packaging film.

48. The multilayer film according to claim 25 in which the starch content of the core layer mixture is at least twice as high as the starch content of the print layer mixture and/or the seal layer mixture.

49. (canceled)
